(19) United States
(12) Patent Application Publication
(10) Pub. No.: US 2026/0321854 A1
(43) Pub. Date: Oct. 15, 2026

(54) MODULAR BATTERY SYSTEM AND INTERFACE FOR WEAPON-MOUNTED DEVICE

(71) Applicant: WILCOX INDUSTRIES CORP., Newington, NH (US)

(72) Inventors: James W. Teetzel, Portsmouth, NH (US); Michael A. Vankevich, Portland, ME (US)

(21) Appl. No.: 19/463,965

(22) Filed: Jan. 29, 2026

Related U.S. Application Data
(60) Provisional application No. 63/762,180, filed on Feb. 24, 2025.

(51) Int. Cl. H01M 50/264; F41G 1/00; H01M 50/213; H01M 50/247; H01M 50/258; H01M 50/267; H01M 50/284; H01M 50/296; H01M 50/298

(52) U.S. Cl. CPC H01M 50/264; F41G 1/00; H01M 50/213; H01M 50/247; H01M 50/258; H01M 50/267; H01M 50/284; H01M 50/296; H01M 50/298; H01M 2220/30

(57) ABSTRACT

A modular battery system and interface includes a weapon-mounted device and battery module. A battery recess is configured to receive the battery module or a connector from a modular battery system. Electrical contact pins in the battery recess contact aligned, facing contact pads in the battery module. The device includes a battery retention mechanism including a release lever; a retention button; and locking lugs that move in a forward direction when the retention button is pressed and a rearward direction when the retention button is released. The release lever and retention button are in mechanical communication such that the retention button can only be pressed when the release lever is depressed. The battery module includes a protrusion that mates with a receptacle of the device and a lug engagement recess that accepts the locking lugs of the device and locks the locking lugs in place in the rearward position.

### CROSS REFERENCE TO RELATED APPLICATION

This application claims the priority benefit of U.S. provisional Application No. 63/762,180 filed Feb. 24, 2025. The aforementioned application is incorporated herein by reference in its entirety.

### BACKGROUND

The present disclosure relates to a modular battery system and interface for a weapon-mounted device and is particularly well-adapted for a weapon-mounted laser device. Laser devices, such as laser aiming modules, laser range finders, fire control systems, and the like typically come with an integrated battery power source. With devices often being connected via power and data with other devices, the integrated battery power source is not always sufficient or appropriate for certain situations. As the battery power source is integrated into the device, however, the user does not have configurability. Therefore, there is a need for a device that may accommodate several different types of battery modules and different types of battery modules that are all adapted for use with that device. The present disclosure provides a modular battery system and interface that overcomes the above-referenced problems and others.

### SUMMARY

In one aspect, a modular battery system and interface comprises a device and at least one battery module. The device comprises a device housing; a battery recess within the device housing, the battery recess comprising a plurality of electrical contact pins for power and data transfer and a receptacle; a battery retention mechanism comprising a release lever adapted to be depressed or released, a retention button adapted to be pressed or released, and locking lugs that move in a forward direction when the retention button is pressed and in a rearward direction when the retention button is released; and a release lip extending from the device housing that catches the release lever when released, wherein the release lever and the retention button are in mechanical communication such that the retention button can only be pressed when the release lever is depressed. The at least one battery module is configured to fit within the battery recess of the device, each of the at least one battery modules comprising a battery housing and at least one battery disposed within the battery housing; a circuit board disposed within the battery housing; a battery bulkhead disposed on the battery housing, the battery bulkhead comprising a plurality of contact pads that aligns with the plurality of electrical contact pins; a protrusion configured to mate with the receptacle of the device; and a lug engagement recess that accepts the locking lugs of the device and locks the locking lugs in place in the rearward or aft position.

In a more limited aspect, the at least one battery module is at least two battery modules.

In a still more limited aspect, the at least two battery modules are different from one another.

In another more limited aspect, the battery retention mechanism of the device further comprises a release lever spring that urges the release lever to be released and caught by the release lip at least one retention button spring that urges the retention button to be released, wherein the release lever spring and the at least one retention button spring are oriented substantially perpendicularly from one another.

In another more limited aspect each locking lug of the battery retention mechanism of the device comprises a T-stem and a T-crossbar crossing over the T-stem and the lug engagement recess of the battery module comprises a channel sized to accommodate movement of the T-stems of the locking lugs; a block on either side of the channel corresponding to each of the locking lugs, the blocks configured to catch the T-crossbars of the locking lugs; and spaces on either side of the channel disposed between the blocks, the spaces configured to allow the T-crossbars of the locking lugs to pass therethrough.

In another more limited aspect, the at least one battery module further comprises an external connection port.

In another more limited aspect, the plurality of electrical contact pins extend from a contact plate that is held in place in the battery recess by a power and data bulkhead.

In a still more limited aspect, the power and data bulkhead is affixed to the battery recess with bulkhead threaded fasteners.

In another more limited aspect, the plurality of electrical contact pins comprises eight or more electrical contact pins and the plurality of electrical contact pads on the battery bulkhead comprises eight or more contact pads.

In a more limited aspect, the at least one battery module is configured for bidirectional data communication and power distribution.

In a more limited aspect, the at least one battery module comprises a temperature sensor.

In a still more limited aspect, the temperature sensor is an analog thermistor.

In a more limited aspect, the at least one battery module comprises a power switch.

In a still more limited aspect, the power switch is externally regulated and configured to receive remote commands.

In a more limited aspect, the at least one battery module comprises a data transceiver.

In a still more limited aspect, the data transceiver is a control area network transceiver.

In a more limited aspect, the at least one battery module comprises a multiplexer.

In a still more limited aspect, the multiplexer is configured to switch between at least USB and UART subsystems.

In a more limited aspect, the at least one battery module comprises a power gauge.

In a still more limited aspect, the power gauge provides information regarding at least battery charge and battery health.

In a more limited aspect, the at least one battery module comprises a light emitter.

In a still more limited aspect, the light emitter emits visible or infrared light.

In a further more limited aspect, the light emitter comprises a laser edge emitter, a vertical cavity surface emitting laser, or a light emitting diode.

In a further more limited aspect, the at least one battery module further comprises drive circuitry for operating the light emitter.

In a further more limited aspect, the light emitter comprises a light emitter power source.

In a further aspect, a modular battery system and interface comprises a device and at least one battery module. The device comprises a device housing; a battery recess within the device housing, the battery recess comprising a plurality of electrical contact pins for power and data transfer and a receptacle and at least one battery retention threaded fastener. The at least one battery module is configured to fit within the battery recess of the device, each of the at least one battery modules comprising a battery housing and at least one battery disposed within the battery housing; a circuit board disposed within the battery housing; a battery bulkhead disposed on the battery housing, the battery bulkhead comprising a plurality of contact pads that aligns with the plurality of electrical contact pins; and at least one battery retention threaded receptacle that aligned to mate with the at least one battery retention threaded fastener of the device.

In another aspect, a modular battery system and interface comprises a device comprising a remote connector port; at least one battery module; and a remote connector that connects the device from the remote connector port to the at least one battery module.

Advantages and benefits of the present invention will become apparent to those of ordinary skill in the art upon reading and understanding the following detailed description of the preferred embodiments.

### BRIEF DESCRIPTION OF THE DRAWING

The invention may take form in various components and arrangements of components, and in various steps and arrangements of steps. The drawings, which are not necessarily to scale, are only for purposes of illustrating preferred embodiments and are not to be construed as limiting the invention.

FIG. 1 is an isometric view of a weapon equipped with a device according to a first exemplary embodiment of the present invention.

FIG. 2 is an enlarged isometric view of the device as shown in FIG. 1.

FIG. 3A is a side view of the device as shown in FIG. 1.

FIG. 3B is an enlarged view of the region 3B appearing in FIG. 3A.

FIG. 4A is an isometric view of a battery module being placed in position with the device.

FIG. 4B is an isometric view of the battery module in position with the device.

FIG. 5A is a rear view of the device with the battery module in position with cutaway detail of the battery retention mechanism.

FIG. 5B is a side view of the device with the battery module in position with cutaway detail of the battery retention mechanism.

FIG. 6A is an isometric view of the device with the locking lugs of the battery retention mechanism engaged.

FIG. 6B is an isometric view of the device with the locking lugs of the battery retention mechanism disengaged.

FIG. 7 is an exploded isometric view of a device and a battery module.

FIGS. 8A-8C are isometric views of a device with three different battery modules interchangeably affixed directly to the device.

FIG. 9 is an isometric view of a weapon equipped with a device connected to a remote battery module.

FIG. 10 is an isometric view of a battery module.

FIG. 11 is an exploded isometric view of a second embodiment of a modular system according to the present invention.

FIG. 12 is an exploded isometric view of an exemplary battery module.

FIG. 13 is a diagram illustrating exemplary functionality of the battery module.

### DETAILED DESCRIPTION OF THE PREFERRED EMBODIMENTS

Detailed embodiments of the present development are disclosed herein; however, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used herein the term “substantially perpendicular” means between 80 and 100°.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

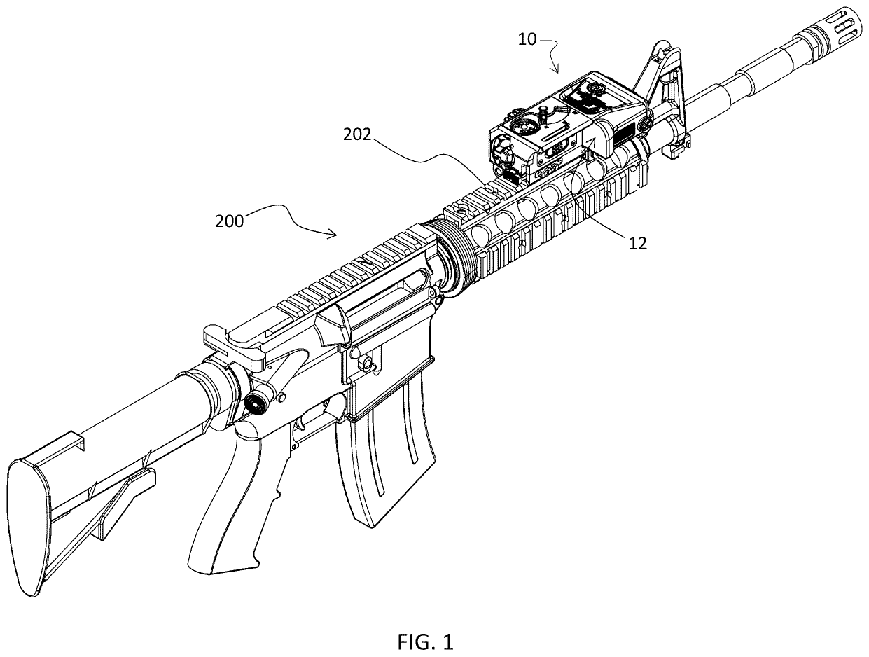

Referring first to FIG. 1, an isometric view of a weapon 200 equipped with a weapon-mounted accessory device 10 is provided. In embodiments, the device 10 is a laser device, such as a laser aiming device, laser range finder, fire control system, or the like, adapted for detachable mounting to a rail system 202 of the weapon 200. Exemplary weapon rail interfaces include Picatinny-style rail interfaces (generally T-shaped rail interfaces with beveled edges and integrated recoil grooves), such as MIL-STD-1913 and STANAG 4694 rail interfaces. Alternatively, the rail system 202 is a slot rail interface, such as an M-LOK(TM) or M-LOK-compatible rail interface. Although the device 10 embodiment shown is a weapon-mounted laser device, one skilled in the art will recognize that the device 10 may be incorporated into other weapon-mounted devices, as well as devices not intended for use with weapons.

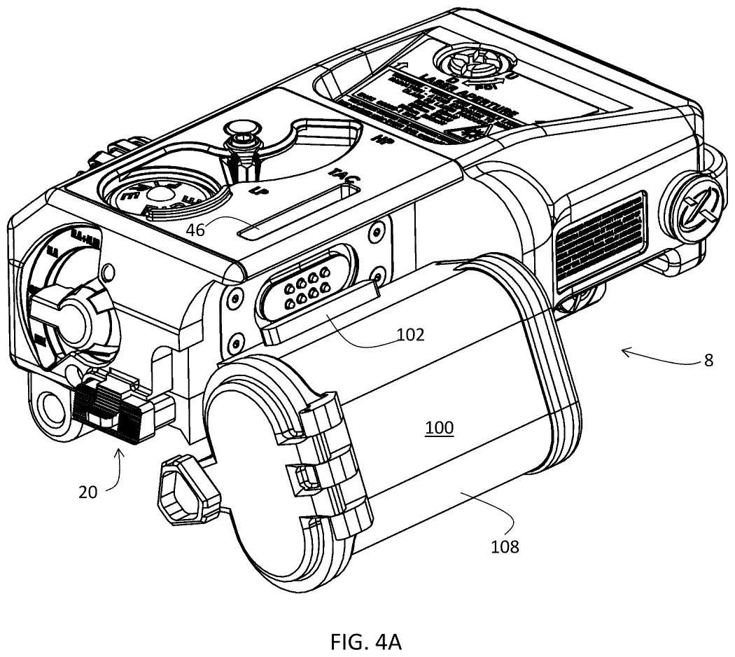

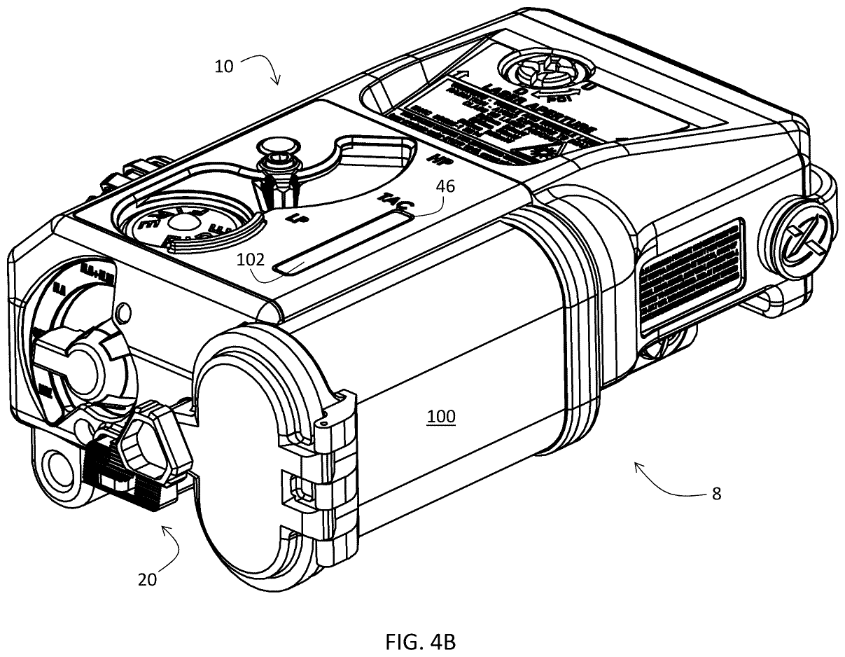

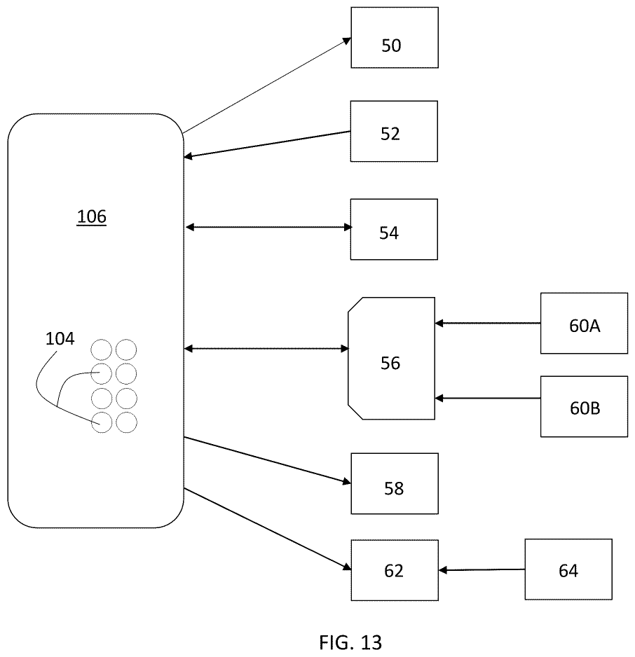

A modular system and interface 8 (hereinafter “modular system 8”) includes the device 10 and at least one battery and data communication module 100 (see, e.g., FIG. 4A). The battery and data communication module 100 may be positioned and maintained in position in a battery recess 12. Hereinafter, battery and data communication module 100 is referred to as “battery module 100,” but as described in detail below, especially with reference to FIG. 13, battery module 100 and device 10 provide a platform for data communication, in addition to power.

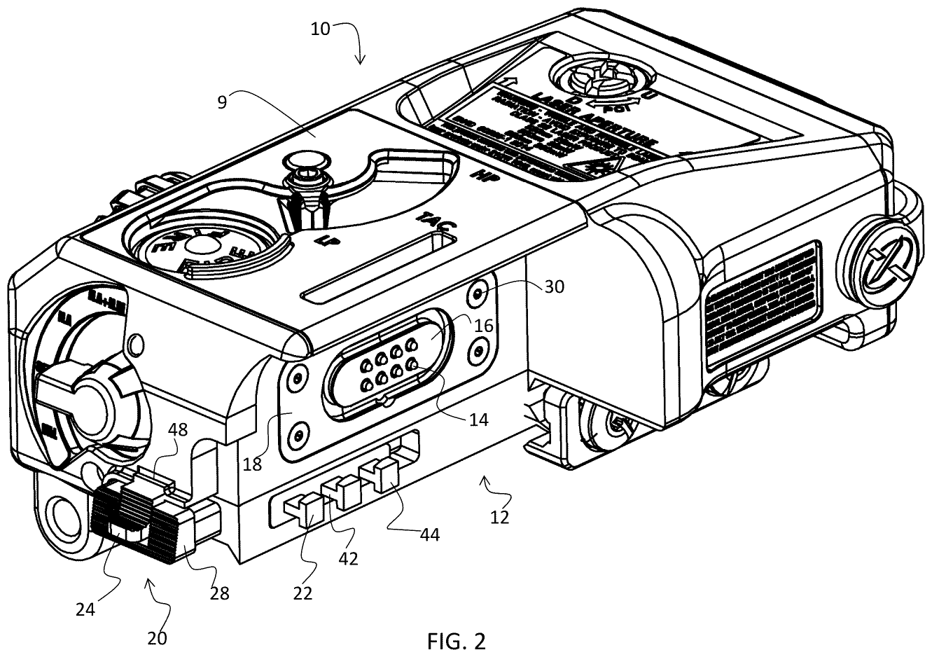

Now referring to FIG. 2, an isometric view of the device 10 as shown in FIG. 1 is provided. The battery recess 12 is sized and shaped to snugly receive a battery module 100, as discussed below. Again, it is understood that battery recess 12 includes features to enable data communications functions, in addition to power functions. The device 10 includes a housing 9 having a receptacle 46 configured to interlock with a complementary protrusion 102 of the battery module 100, as discussed below with reference to FIG. 4A. In the illustrated embodiment, the protrusion 102 is an elongated tongue and the receptacle is an elongated slot, although it will be recognized that the receptacle 46 and protrusion 102 may take various shapes and forms. In the illustrated embodiment the receptacle 46, the receptacle 46 is disposed on an upper surface of the housing 9.

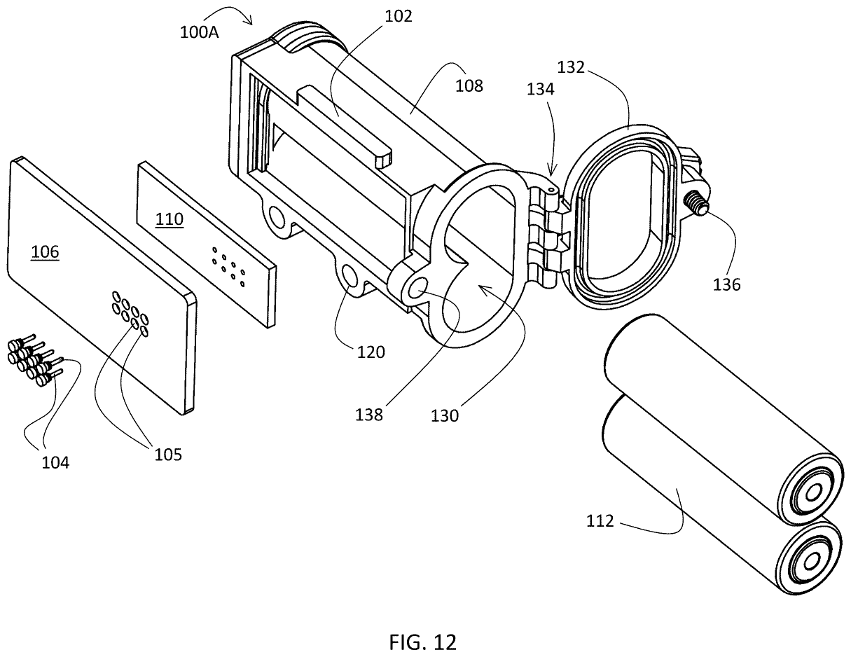

The battery recess 12 also includes contact pins 14 extending from a contact plate 16. The contact pins 14 are electrical contact pins for power and data transfer. In embodiments, the pins 14 are spring-loaded telescoping (pogo) pins. The contact pins 14 are positioned to establish electrical contact with respective contact pads 104 on a battery bulkhead 106 on the battery module 100, such that the contact pins 14 are placed in electrical communication with a control circuit board (such as a printed circuit board, flex circuit board, or the like) 110 disposed behind the battery bulkhead 106 (e.g., as shown in FIG. 12), thereby allowing power and data transfer between the device 10 and the battery module 100. In embodiments, the circuit board 110 includes one or more sensors configured to measure one or more electrical parameters associated with the batteries 112, such as voltage, current, temperature, and so forth. In embodiments, the circuit board 110 further includes control logic, which may be implemented as hardware, software, firmware, or a combination thereof. In embodiments, the control logic is configured to determine a state of charge of the batteries 112 and communicate state of charge information to the device 10, e.g., for display to a user in human viewable form. In embodiments, the control logic is configured to transmit additional operational data, such as temperature, voltage, current, or metric for battery monitoring and diagnostics.

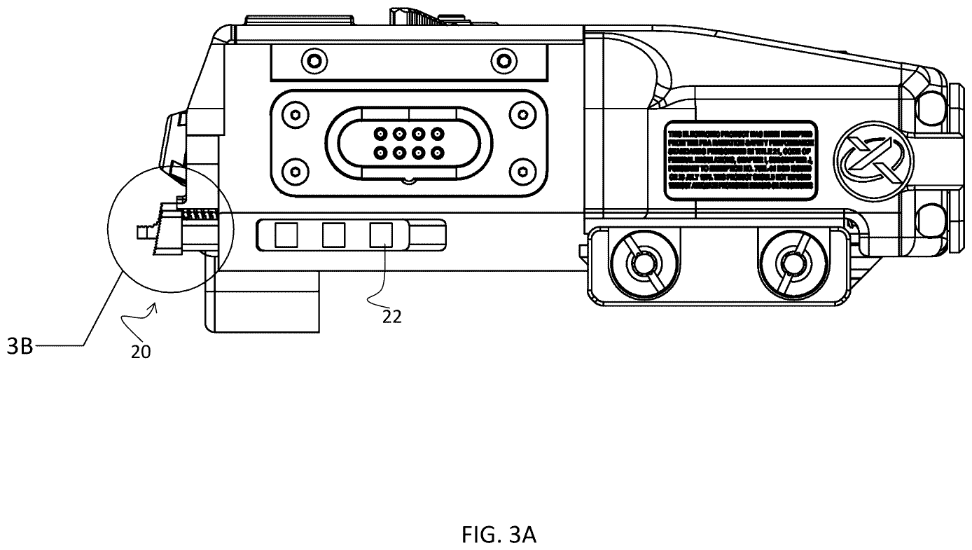

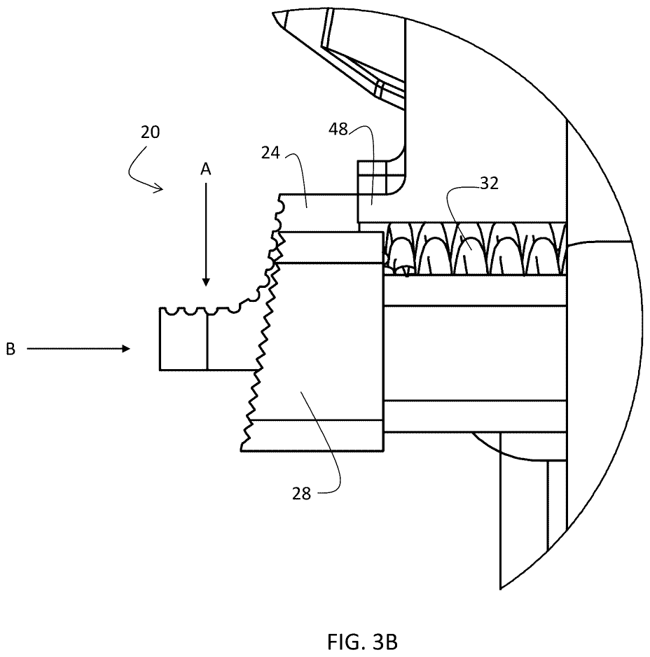

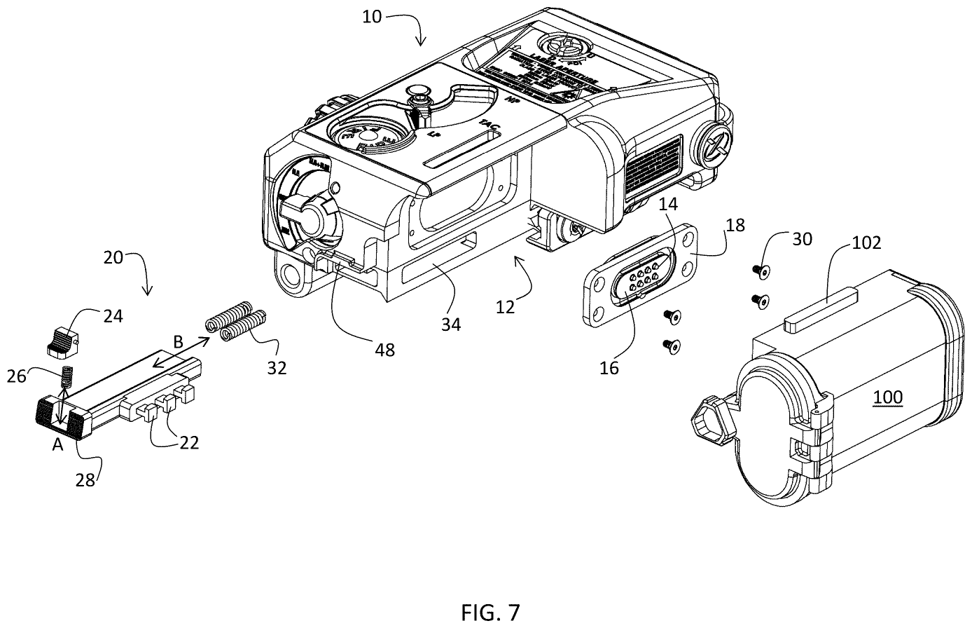

The contact plate 16 is surrounded and held in place by a power and data bulkhead 18. In embodiments, the bulkhead 18 is secured within the battery recess 12 by bulkhead threaded fasteners 30. A battery retention mechanism 20 engages with the battery module 100 to securely hold the battery module 100 in place within the battery recess 12 of the device 10. The battery retention mechanism 20 includes locking lugs 22, a release lever 24, a release lever spring 26, a retention button 28, and retention button springs 32. The components and action of the battery retention mechanism 20 are discussed in more detail with reference to FIGS. 3A, 3B, and 7. In embodiments, the locking lugs 22 are T-shaped with a T-stem 42 extending outward from the device housing 9 of the device 10 and a T-crossbar 44 crossing over the T-stem 42. The device 10 includes a release lip 48 that engages with the release lever 24 such that the retention button 28 may not be pressed inward until the release lever 24 is depressed downward to disengage with the release lip 48. As such, the release lever 24 and the retention button 28 are in mechanical communication such that the retention button 28 can only be pressed once the release lever 24 is depressed.

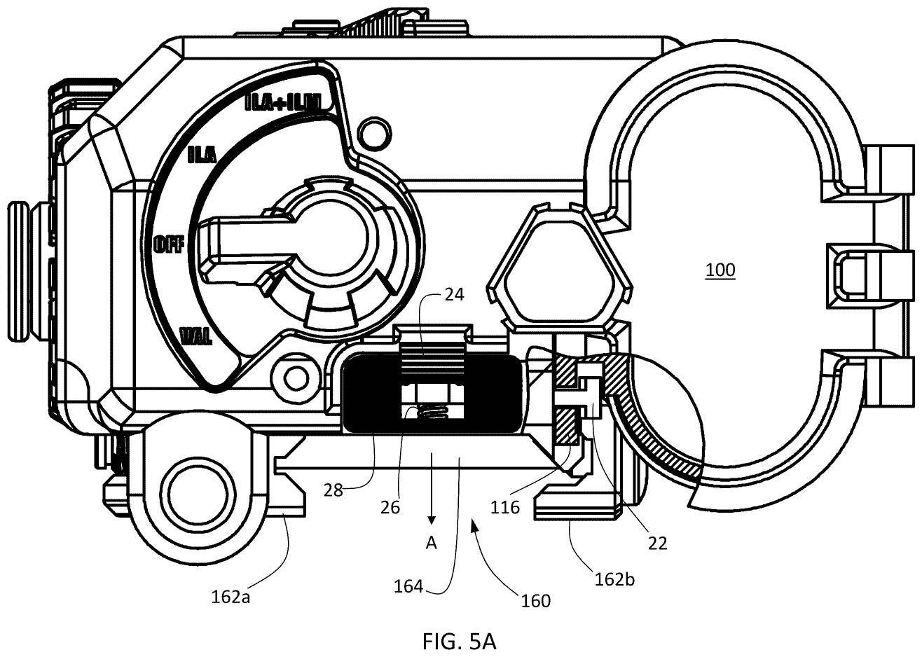

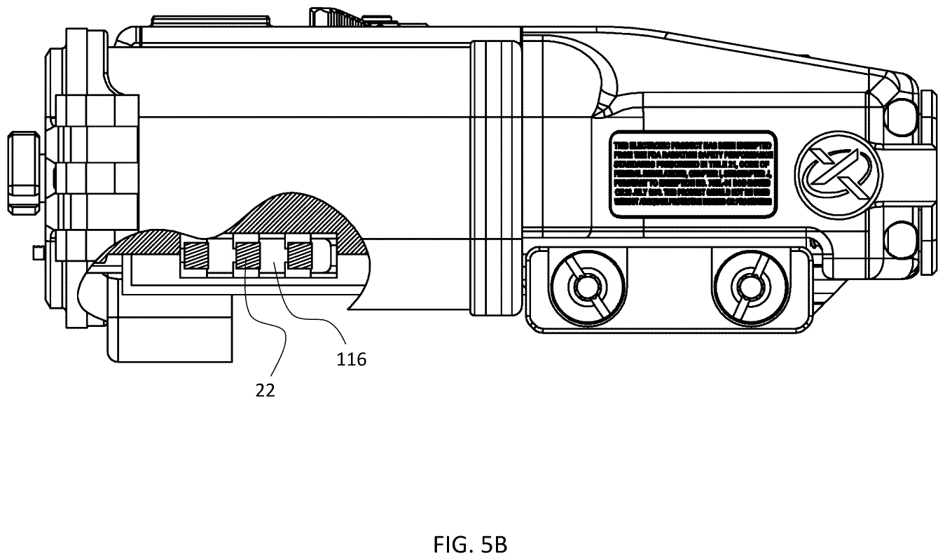

Now referring to FIGS. 3A and 3B, a side view of the device 10 and an enlarged view of the detail of the battery retention mechanism 20 are provided, respectively. As shown most clearly in FIG. 3B, the release lever 24 is caught on the release lip 48 thereby holding the entire battery retention mechanism 20 in place. The release lever 24 must first be depressed in the direction of the arrow A so that it is no longer caught on the release lip 48. This depression protects against accidental ejection of the battery module 100 during weapon recoil. Once the release lever 24 is depressed, the retention button 28 may then be pressed in the direction of the arrow B, substantially perpendicular to the direction of the arrow A. The different directions of arrows A and B ensure that the battery retention mechanism 20 is only activated through two deliberate steps-depression of the release lever 24 in the direction of the arrow A followed by pressing the retention button 28 in the direction of the arrow B. The retention button 28 is pressed against the urging of the retention button springs 32. When the retention button 28 is pressed and released along the arrow B, the locking lugs 22 move fore and aft, respectively, to engage the battery module 100. When the retention button 28 is pressed, the locking lugs 22 are moved so that the battery module 100 may be positioned within the battery recess 12. As explained with reference to FIGS. 5B, 6A, 6B, and 9, the battery module 100 includes a lug engagement recess 116 shaped to engage with the locking lugs 22.

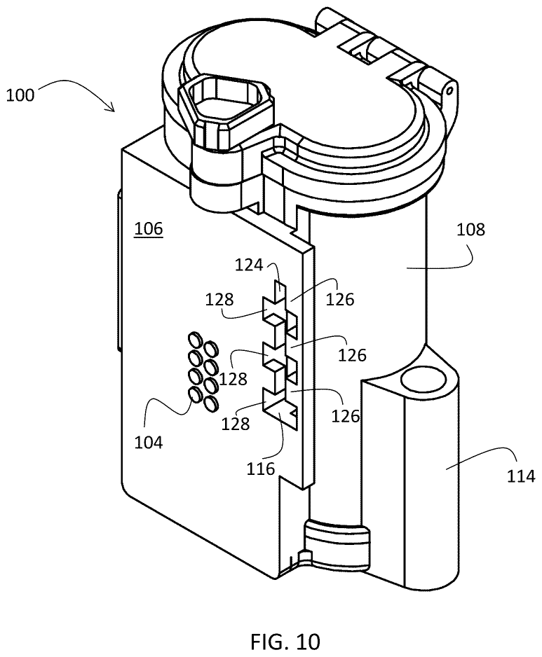

Now referring to FIGS. 4A and 4B, isometric views of the battery module 100 being placed in position within the battery recess 12 and the battery module 100 in position with the device 10 are provided. Together, the device 10 and the battery module 100 are referred to herein as the modular system 8. A battery module housing 108 defines a battery compartment 130 (see FIG. 12) for receiving one or more batteries 112 (see FIG. 12) and includes the protrusion 102, which is positioned into the receptacle 46 of the housing 9 adjacent the battery recess 12. Then, the release lever 24 is pressed downward; the retention button 28 is pressed inward; the battery module 100 is rocked into the battery recess 12; and the release lever 24 and retention button 28 are released. Once the retention button 28 is released, the locking lugs 22 will slide into engagement within the lug engagement recess 116 of the battery housing 108 (shown in FIG. 10), thereby holding the device 10 and the battery module 100 in place, as shown in FIG. 4B, such that the contact pins 14 extending from the device 10 are in electrical and communicative contact with the contact pads 104 on the battery module 100. In FIG. 4B, the protrusion 102 of the battery module 100 is snugly in place within the receptacle 46 of the device 10.

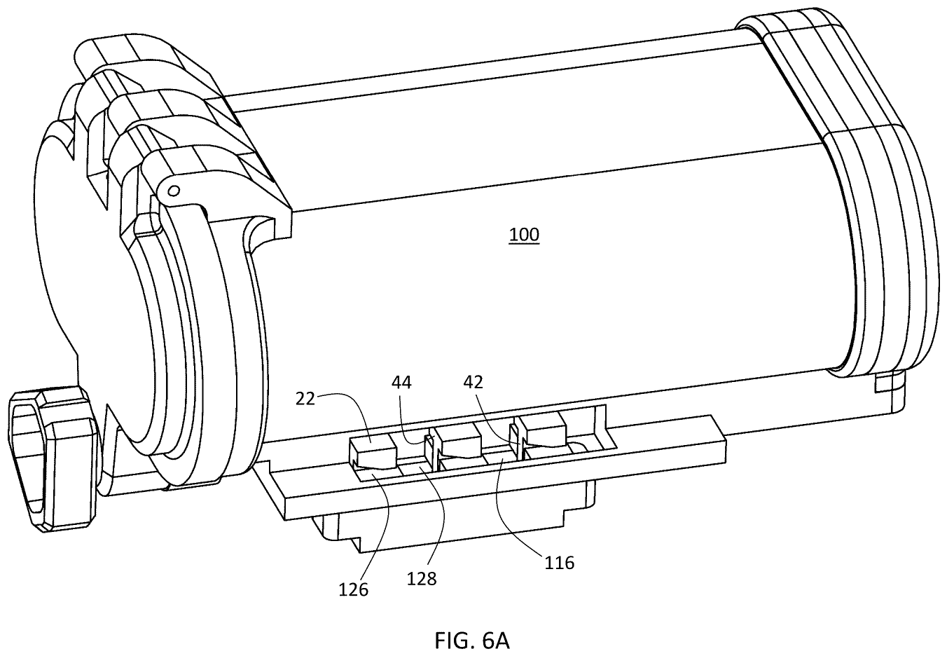

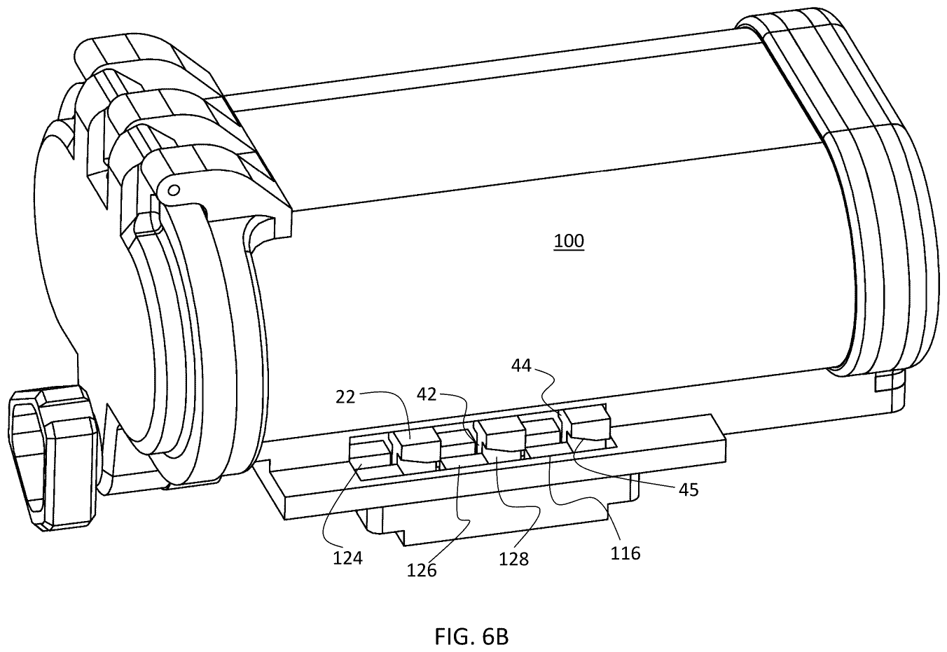

Now referring to FIGS. 5A and 5B, rear and side views of the device 10 with the battery module 100 in position with cutaway details of the locking lugs 22 are provided, respectively. When the release lever 24 of the battery retention mechanism 20 is depressed in the direction of the arrow A, against the urging of the release lever spring 26, the retention button 28 can then be pressed in the direction indicated by arrow B (see FIG. 3B) to move the locking lugs 22 in the forward direction to engage with the lug engagement recess 116 of the battery module 100. When the retention button 28 is pressed against the urging of the retention button springs 32, the locking lugs 22 are positioned within the lug engagement recess 116 of the battery module 100 in a disengaged position, as shown in FIG. 6B. When the retention button 28 is released, the locking lugs 22 are moved rearward by the urging of the springs 32 such that they are positioned within the lug engagement recess 116 of the battery module 100 in an engaged position, as shown in FIG. 6A. As best seen in FIG. 5A, the device 10 includes a rail clamp assembly 160 including opposing rail clamp members 162a and 162b which are configured for releasable clamping engagement with the rail interface 202. A transverse drawbar 164 for selectively increasing and decreasing the clamping force is configured to fit withing a transverse recoil groove of the rail interface 202.

Now referring to FIGS. 6A and 6B, isometric views of the battery module 100 with the locking lugs 22 engaged and disengaged, respectively, are provided. In embodiments, the lug engagement recess 116 forms a channel 124 through which the T-stems 42 of the locking lugs 22 move fore and aft through manually pressing and releasing, respectively, of the retention button 28. The lug engagement recess 116 further includes a series of blocks 126 on either side of the channel 124, the number of the series of blocks 126 corresponding to the number of locking lugs 22. Between each set of right and left blocks 126, the lug engagement recess 116 includes a space 128 on either side of the channel 124. The locking lugs 22 are engaged with the battery module 100 through the lug engagement recess 116 when the T-stem 42 of the locking lugs 22 are disposed within the channel 124 between the blocks 126, as shown in FIG. 6A. The T-crossbar 44 extends over the blocks 126 on either side, thereby holding the device 10 and the battery module 100 in place together. This positioning occurs when the retention button 28 has been released. In embodiments, the T-crossbars 44 have ramped or inclined surfaces 45 configured to facilitate sliding movement past the corresponding blocks 126.

The locking lugs 22 are disengaged from the battery module 100 when the T-stem 42 of the locking lugs 22 are disposed within the channel 124 such that there is space 128 on either side of the locking lugs 22, as shown in FIG. 6B. In this position, the T-crossbar 44 does not hook onto anything to hold the device 10 and the battery module 100 together, as opposed to its positioning as shown in FIG. 6A, where the T-crossbar 44 hooks onto the blocks 126 on either side of the channel 124. It is in the disengaged position shown in FIG. 6B, when the battery module 100 is rocked into place within the battery recess 12, with the locking lugs 22 moving into and through the spaces 128 of the lug engagement recess 116. The disengaged position occurs when the retention button 28 is pressed.

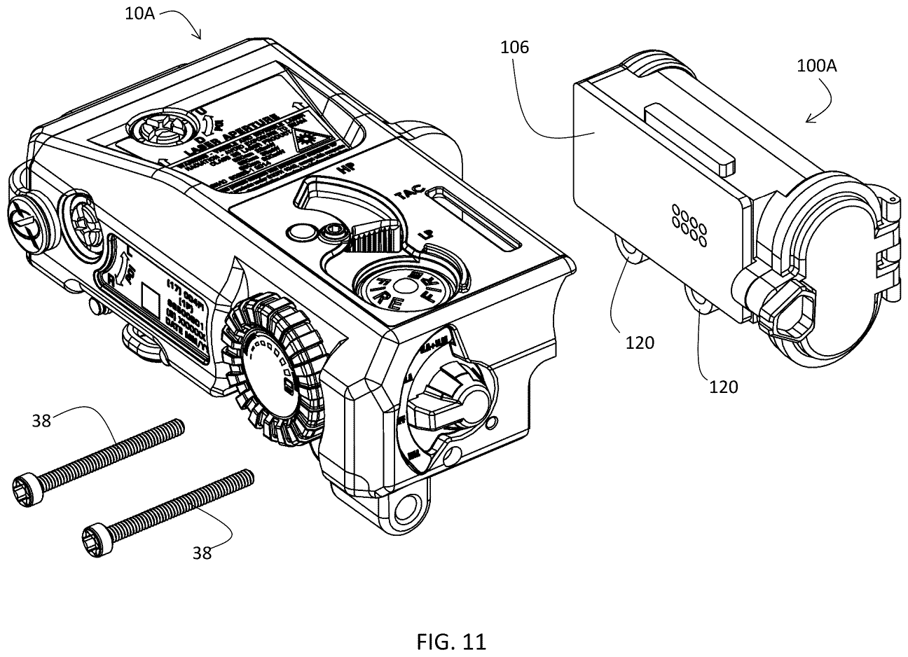

Now referring to FIG. 7, an exploded isometric view of the device 10 and the battery module 100 are provided. The battery retention system 20 includes the locking lugs 22; the release lever 24; the release lever spring 26 that allows the release lever 24 to be depressed and released in the direction of the arrow A; the retention button 28; and the retention button springs 32 that allow the retention button 28 to be pressed and released in the direction of the arrow B. The release lip 48 catches the release lever 24. In embodiments, the locking lugs 22 extend out of device 10 through a lug aperture 34. The housing 9 includes the receptacle 46 which is adjacent the battery recess 12 and which is sized and shaped to accept and hold the protrusion 102 of the battery module 100. The battery recess 12 also includes the bulkhead 18 that holds the contact plate 16 with its contact pins 14 in place. In embodiments, the bulkhead 18 is affixed to device 10 through bulkhead threaded fasteners 30 which pass through clearance opening in the bulkhead 18 and threadably engage aligned openings formed on the housing 9. As shown in FIG. 11, the contact pins 14 are positioned so as to establish electrical contact with the contact pads 104 of the battery module 100.

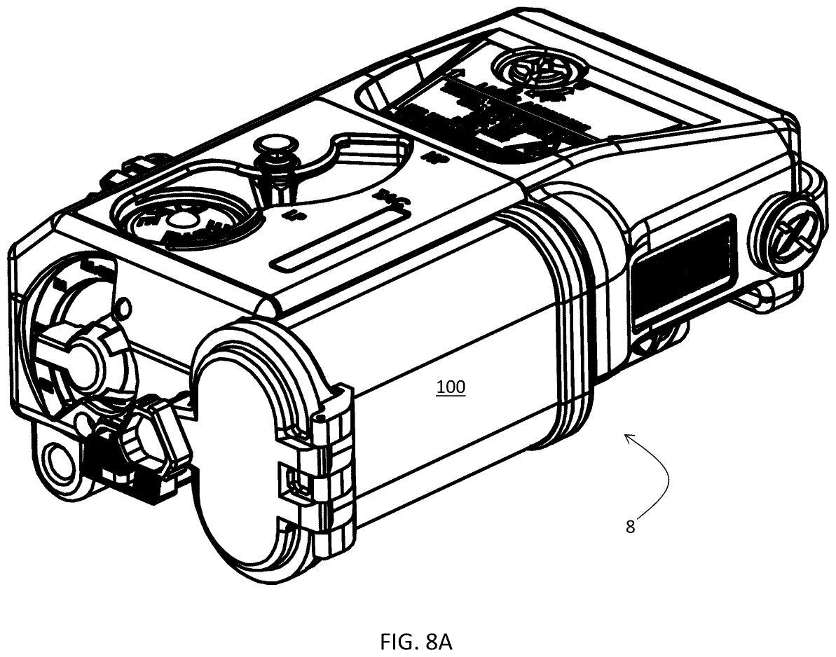

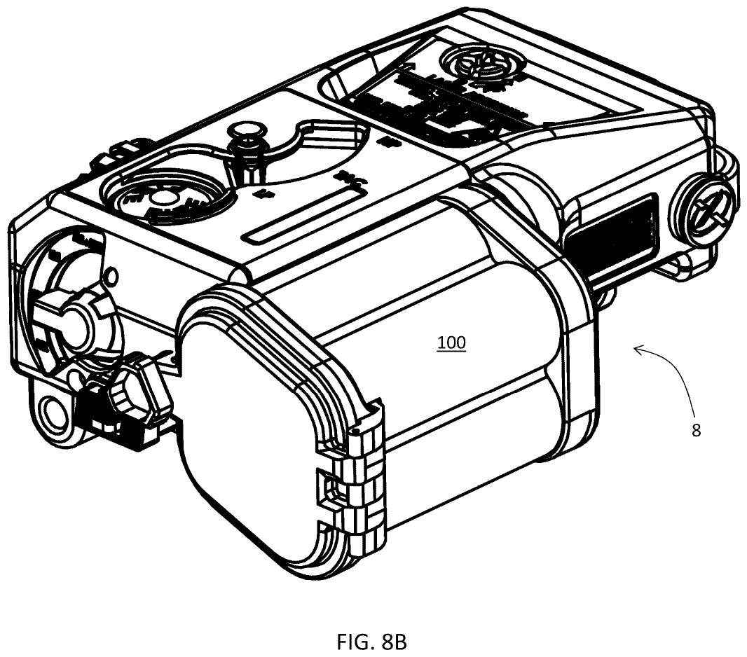

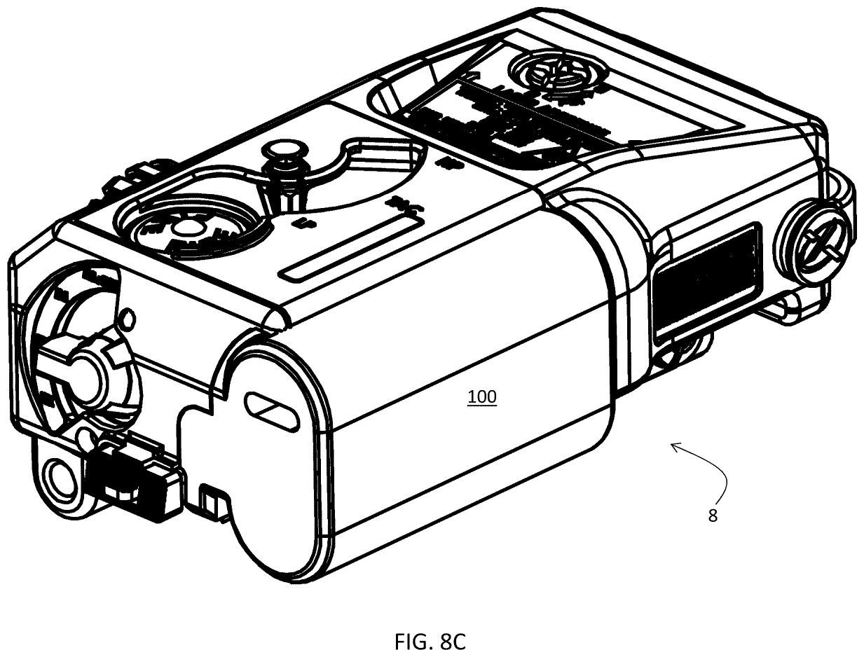

Now referring to FIGS. 8A-8C, isometric views of device 10 with three different battery modules 100 are provided. In FIG. 8A, the battery module 100 accommodates two AA size batteries. In FIG. 8B, the battery module 100 accommodates four AA size batteries. In FIG. 8C, the battery module 100 accommodates a rechargeable lithium battery. In embodiments, modular system 8 includes more than one battery module 100. In embodiments, modular system 8 includes more than one battery module 100 that are of different types. For example, an embodiment of modular system 8 includes device 10 and one of each of the battery modules 100 shown in FIGS. 8A-8C, so that the battery module 100 most appropriate for a specific situation may be selected and easily swapped in. In embodiments, modular system 8 includes more than one battery module 100, where each battery module 100 is of the same type that may be a direct backup/replacement for a drained, spent, damaged, or otherwise unusable battery module 100.

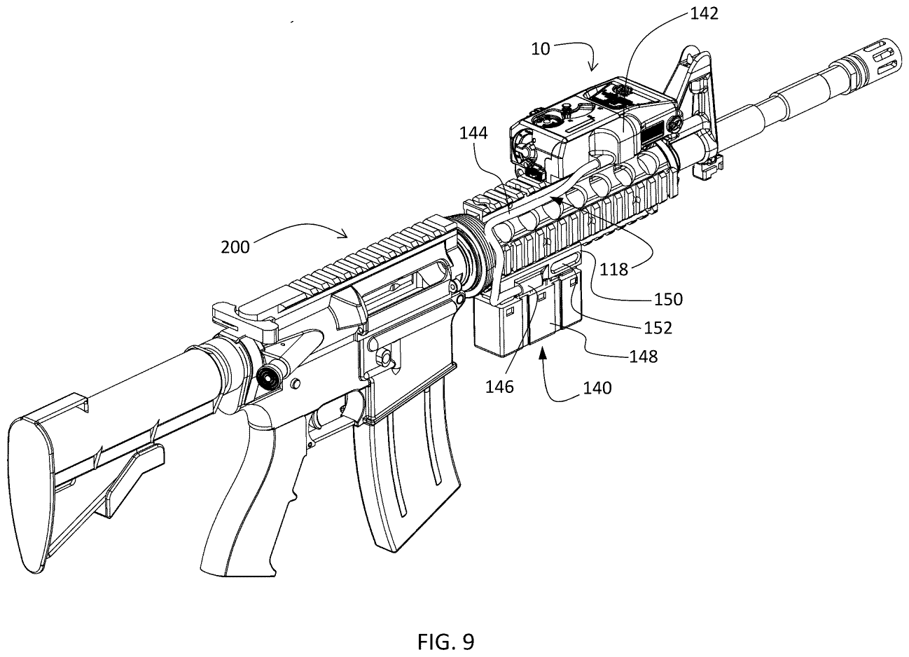

Now referring to FIG. 9, an isometric view of a weapon 200 equipped wherein the device 10 is coupled to a remote battery module 140, which is attached at a remote position on the rail interface 202. In the illustrated embodiment, the battery module 100 is removed from the battery recess 12 and a cable assembly 118 is provided to electrically couple the device 10 and the remote battery module 140. The cable assembly 118 includes a first connector end 142 with a connector housing that mates with the battery recess 12 in the same manner as the battery pack 100, such that the first connector end 142 is interchangeable with the battery pack 100. The cable assembly further includes a connector cable 144 and a second connector end 146 is electrically coupled to the remote battery pack 140. In the illustrated embodiment, the remote battery module 140 includes a battery pack, such as Small Tactical Universal Battery (STUB) battery pack 148, which is coupled to a slot rail interface segment 150. The second connector end 146 is configured to detachably connect to a slot 152 in the slot rail interface segment 150 which includes internal circuitry (not shown) for establishing electrical contact with the battery pack 148. The slot rail interface segment 150 includes multiple slots 152 to allow the remote battery module 140 to power multiple devices.

Now referring to FIG. 10, an isometric view of the battery module 100 is provided. The battery module 100 is housed in the battery housing 108. One side of the housing 108 includes the battery bulkhead 106. The battery bulkhead 106 includes the contact pads 104 that are configured to electrically couple with the contact pins 14 of device 10. The battery bulkhead 106 also includes lug engagement recess 116 that engages with the locking lugs 22 of device 10. Lug engagement recess 116 includes channel 124 along its entire length. On either side of channel 124 are alternating blocks 126 and spaces 128. In embodiments, the number of sets of blocks 126 corresponds with the number of locking lugs 22 on device 10. When the battery module 100 is being rocked into battery recess 12 of device 10, the retention button 28 will be depressed so that the locking lugs 22 will be placed within the spaces 128 of the lug engagement recess 116. Specifically, the T-crossbars 44 of the locking lugs 22 are able to pass through the spaces 128. Once the retention button 28 is released, the retention button springs 32 will push the locking lugs 22 into an engaged position within the lug engagement recess 116, such that the T-crossbars 44 are held by the blocks 126. In embodiments such as that shown in FIG. 10, the battery module 100 also includes an external connection port 114. The external connection port 114 allows for power passthrough from a remote-mounted battery. In embodiments, the external connection port 114 also connects to a computer based information handling system. In embodiments, the computer based information handling system is for power and data distribution and/or controlling operation of the device 10. In certain embodiments, the computer-based information handling system is selected from a smartphone, handheld data terminal, tablet computer, laptop computer, wearable device, or other mobile computing device. In certain embodiments, the computer-based information handling system is a central network controller as described in commonly owned U.S. patent application Ser. No. 18/381,937 filed on Oct. 19, 2023, entitled “Central Network Controller for Weapon Accessory Devices,” which is incorporated herein by reference in its entirety. In certain embodiments, the connection port is operable to couple a weapon mounted remote control unit for remotely controlling laser aiming module functions of the device 10.

Now referring to FIG. 11, an exploded isometric view of a third embodiment of a device 10 and a battery module 100A are provided. In this embodiment, the battery retention mechanism 20 is replaced with a semi-permanent attachment mechanism that allows the device 10 to be configured at a weapon depot or other centralized facility. The battery module 100A includes battery retention threaded receptacles 120. Battery retention threaded fasteners 38 pass through clearance openings (not shown) and engage with the battery retention threaded receptacles 120 to hold the device 10A and the battery module 100A securely together.

Now referring to FIG. 12, an exploded isometric view of the battery module 100A is provided. Although the battery module 100A includes battery retention threaded receptacles 120, indicating that the battery module 100A is designed for use in connection with device 10A, all other components shown are common to the battery module 100 as well. The battery module 100A includes a battery housing 108 that houses batteries 112.

The battery module 100A includes a cover 132 which selectively covers the battery compartment 130. Preferably, the cover 132 includes a sealing ring or gasket for preventing entry of moisture or other contamination in to the battery compartment 130. In the illustrated embodiment the cover 132 is coupled to the main body of the housing 108 via a hinge 134 and is secured in the closed position by a threaded fastener 136 which threadably engages a threaded opening 136.

One side of the battery housing 108 is a battery bulkhead 106. The battery bulkhead 106 includes contact pads 104 which electrically engage the contact pins 14 (see, e.g., FIG. 7) when the battery module 100A is in place within the battery recess 12 of device 10A. The contact pads 104 pass through respective aligned openings or vias 105 in the battery bulkhead 106 and are in electrical communication with a circuit board 110. The circuit board 110 is positioned behind the bulkhead 106, within the housing 108. The contact pins 14 contact the contact pads 104 on the bulkhead 106 to electrically couple the device 10A and the battery module 100A and allow power and data transfer therebetween.

Now referring to FIG. 13, a diagram illustrating exemplary functionality of battery module 100 is provided. As discussed above, battery bulkhead 106 of battery module 100 includes contact pads 104 that coincide with different functionalities of battery module 100, as both a data communication and power interface. In embodiments as shown in FIG. 13, battery module 100 includes a temperature sensor 50, a power switch 52, a data transceiver 54, a multiplexer 56, a power gauge 58, and a light emitter 62. In embodiments, these functions correspond to individual contact pads 104. In embodiments, the system includes a signal routing interface (not shown), such as a data and/or signal bus, a connector pin breakout, ribbon cable, or the like configured to route signals, including data, power, and communication lines, to designated contacts 104 of the connector 106. The signal routing interface may facilitate communication between various components, such as sensors, input/output devices, and external systems, and may be implemented using one or more buses, conductive traces, flexible circuits, or other signal transmission pathways, as would be understood by persons skilled in the art.

In embodiments, the temperature sensor 50 is an analog thermistor configured to output an analog electrical signal (e.g., voltage or current) representative of temperature measured at the battery module 100 for sending to a remote location, such as an operations control center. In embodiments, the power switch 52 is an externally regulated power switch that receives remote commands. In embodiments, the data transceiver 54 is a control area network (CAN) transceiver, such as a 3.3 V or 5 V transceiver for data transfer. In embodiments, the multiplexer 56 is a device that selects between input signals, such as analog or digital input signals, and forwards the selected input to a single output. In embodiments, multiplexer 56 can switch between different communication protocol subsystems 60, such as USB subsystem 60A and UART subsystem 60B. In embodiments, power gauge 58 sends data regarding the state of battery charge, battery health, and other identification parameters. In embodiments, power gauge 58 is an internal coulomb counter.

In embodiments, light emitter 62 is an auxiliary emitter packaged into battery module 100. In embodiments, light emitter 62 is an especially wide divergence illuminator that does not require boresight adjustment by the user. In embodiments, light emitter 62 emits visible and/or infrared light. In embodiments, light emitter 62 is or is based on a laser edge emitter, a vertical cavity surface emitting laser (VCSEL), or a light emitting diode (LED). In embodiments, any drive circuitry necessary for light emitter 62 is packaged into battery module 100, underscoring that battery module 100 is a bidirectional data and power port. In embodiments, light emitter 62 includes its own light emitter power source 64. In embodiments, light emitter 62 is configured to tap into light emitter power source 64, battery 112, remote battery module 140, or any other local or remote power source, as needed. It is understood that the functionality illustrated in FIG. 13 is merely exemplary. Battery module 100 may include less than all of the functionality described herein and may include other common functionality not described herein or some combination thereof.

Battery module 100 is therefore a bidirectional platform interface for data communication and power distribution. It is a data port for communication directly with software hosted in device 10. This allows for use by external remotes and sensors networked with the weapon 200. The battery module 100 provides for sending data to offboard processing that can calculate state of charge and battery health as well as identification parameters. As shown, the interface is bidirectional so that batteries 112 may be charged through battery module 100. The interface on the battery bulkhead 106 can also be used to remote mount upgrade packages, such as additional wireless communication and/or wireless power methods and remote power, such as power sourced from a rail or divorced power pack. The interface can also be used to adapt to alternate connector types, such as those developed and under development by the applicant. The interface supports a number of communication protocols, including but not limited to UART, USB 2.0, analog, and CAN. Through multiplexer 56, these communication protocols are multiplexed out of the port depending on identification parameters.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A modular battery system and interface comprising:
a device comprising a device housing, the device housing defining a battery recess, the battery recess having a plurality of electrical contact pins for power and data transfer therein; and
a receptacle formed in the device housing adjacent the battery recess;
a battery retention mechanism comprising:
a release lever adapted to be depressed or released;
a retention button adapted to be pressed or released;
locking lugs configured to move to a forward position when the retention button is pressed and a rearward position when the retention button is released; and
a release lip extending from the device housing and configured to catch the release lever when the release lever is released;
wherein the release lever and the retention button are in mechanical communication such that the retention button is depressible when the release lever is depressed;
at least one battery module configured to be removably received within the battery recess, each of the at least one battery modules comprising:
a battery housing defining a battery compartment for operably receiving at least one battery;
a circuit board;
a battery bulkhead disposed on the battery housing, the battery bulkhead comprising a plurality of electrical contact pads in electrical communication with the circuit board, each electrical contact pad configured to contact a respective one of the plurality of contact pins when the battery module is received within the battery recess;
a protrusion configured to mate with said receptacle; and
a lug engagement recess configured to accept the locking lugs and lock the locking lugs when the locking lugs are in the rearward position.

2. The modular battery system and interface of claim 1, wherein the at least one battery module comprises two or more battery modules.

3. The modular battery system and interface of claim 2, wherein the two or more battery modules are different from one another and interchangeably receivable within the battery recess.

4. The modular battery system and interface of claim 1, wherein the battery retention mechanism further comprises:
a release lever spring that urges the release lever to be released and caught by the release lip; and
at least one retention button spring that urges the retention button toward the rearward position;
wherein the release lever spring and the at least one retention button spring are oriented substantially perpendicularly from one another.

5. The modular battery system and interface of claim 1, wherein:
each locking lug comprises a T-stem and a T-crossbar crossing over the T-stem; and
the lug engagement recess comprises:
a channel sized to accommodate movement of the T-stems;
a block on either side of the channel corresponding to each of the locking lugs, the blocks configured to catch the T-crossbars; and
spaces on either side of the channel disposed between the blocks, the spaces configured to allow the T-crossbars to pass therethrough.

6. The modular battery system and interface of claim 1, wherein the at least one battery module further comprises an external connection port configured to operably couple the at least one battery module to an external device.

7. The modular battery system and interface of claim 1, wherein the plurality of electrical contact pins extend from a contact plate that is held in place in the battery recess by a power and data bulkhead.

8. The modular battery system and interface of claim 7, wherein the power and data bulkhead is affixed to the battery recess with bulkhead threaded fasteners.

9. The modular battery system and interface of claim 1, wherein:
the plurality of electrical contact pin comprises eight or more electrical contact pins; and
the plurality of electrical contact pads on the battery bulkhead comprises eight or more contact pads.

10. The modular battery system and interface of claim 1, further comprising:
a cable assembly configured to electrically couple the device to a remote battery module;
the cable assembly including a first connector end comprising a connector housing, the connector housing and the battery pack configured to interchangeably engage with the battery recess;
a connector cable electrically coupling the first connector end to a second connector end, the second connector end being configured to electrically couple to a remote battery pack.

11. The modular battery system and interface of claim 10, in combination with the remote battery pack.

12. The modular battery system and interface of claim 11, wherein the remote battery pack is a Small Tactical Universal Battery (STUB) battery pack.

13. The modular battery system and interface of claim 1, wherein the at least one battery module is configured for bidirectional data communication and power distribution.

14. The modular battery system and interface of claim 1, wherein the at least one battery module comprises any one or more of a temperature sensor, an analog thermistor, a power switch, a data transceiver, a control area network transceiver, a multiplexer, a power gauge, a light emitter, a visible light emitter, an infrared light emitter, a laser edge emitter, a vertical cavity surface emitting laser, and a light emitting diode.

15-16. (canceled)

17. The modular battery system and interface of claim 14, wherein, when the at least one battery module comprises a power switch, the power switch is externally regulated and configured to receive remote commands.

18-20. (canceled)

21. The modular battery system and interface of claim 14, wherein, when the at least one battery module comprises a multiplexer, the multiplexer is configured to switch between at least USB and UART subsystems.

22. (canceled)

23. The modular battery system and interface of claim 14, wherein, when the at least one battery module comprises a power gauge the power gauge is configured to provide information regarding at least battery charge and battery health.

24-26. (canceled)

27. The modular battery system and interface of claim 14, wherein, when the at least one battery module comprises a light emitter, the at least one battery module further comprises drive circuitry for operating the light emitter.

28. The modular battery system and interface of claim 14, wherein, when the at least one battery module comprises a light emitter, the light emitter comprises a light emitter power source.

29. A modular battery system and interface comprising:
a device comprising a device housing, the device housing defining a battery recess, the battery recess having a plurality of electrical contact pins for power and data transfer therein; and
at least one battery module configured to fit within the battery recess of the device, each of the at least one battery modules comprising:
a battery housing defining a battery compartment for operably receiving at least one battery;
a circuit board;
a battery bulkhead disposed on the battery housing, the battery bulkhead comprising a plurality of electrical contact pads in electrical communication with the circuit board, each electrical contact pad configured to contact a respective one of the plurality of contact pins when the battery module is received within the battery recess; and
at least one battery retention threaded fastener configured to detachably secure the battery housing to the device housing.
